(19) United States
(12) Patent Application Publication
(10) Pub. No.: US 2025/0332061 A1
(43) Pub. Date: Oct. 30, 2025

(54) MASSAGER

(71) Applicants: Junpeng Wu, Shenzhen (CN); Dongguan Mimao Electronic Technology Co., Ltd., Dongguan (CN); Shenzhen Zhonghongtian Technology Co., Ltd., Shenzhen (CN)

(72) Inventor: Qinling Wang, Heyuan (CN)

(21) Appl. No.: 18/977,984

(22) Filed: Dec. 12, 2024

Related U.S. Application Data
(63) Continuation-in-part of application No. 18/644,172, filed on Apr. 24, 2024, now Pat. No. 12,178,773.

(51) Int. Cl. A61H 19/00; A61H 21/00; A61H 23/02

(52) U.S. Cl. CPC A61H 19/32; A61H 19/34; A61H 21/00; A61H 23/0263; A61H 2023/0281; A61H 2201/1215; A61H 2201/14; A61H 2201/1472; A61H 2201/1676; A61H 2201/1692

(57) ABSTRACT

A massager is provided and includes a clamping part, a driving mechanism, a positioning portion and a driving member. The clamping part includes a first engagement portion and a second engagement portion which are opposite to each other and made of a flexible material, with a cavity defined between the first engagement portion and the second engagement portion. The driving mechanism includes at least one swing arm which is disposed in at least one of the first engagement portion and the second engagement portion for driving the at least one of the first engagement portion and the second engagement portion to move toward or away from the other. The positioning portion performs as a massaging portion made of a flexible material. The driving member is provided in the positioning portion to drive the positioning portion to move or to vibrate.

### CROSS-REFERENCE TO RELATED APPLICATIONS

The present application is a Continuation in part Application of U.S. patent application Ser. No. 18/644,172, filed on Apr. 24, 2024, which claims the priority of Chinese Patent Application No. 202420778432.4, filed on Apr. 15, 2024, the entire contents of which are hereby incorporated by reference.

### TECHNICAL FIELD

Embodiments of the present invention relate to sex aids, in particular to a massager having a clamping part and a positing portion performing as a massaging portion.

### DESCRIPTION OF THE PRIOR ART

Massagers, as a type of health care device, have been developed in various shapes, sizes, and functions to provide massage and/or stimulation to various parts of the human body. However, some existing massagers are easy to fall off during use, resulting in bad user experiences.

### SUMMARY

Embodiments provide a massager including a clamping part, a driving mechanism, a positioning portion and a driving member. The clamping part includes a first engagement portion and a second engagement portion which are opposite to each other and made of a flexible material, with a cavity defined between the first engagement portion and the second engagement portion. The driving mechanism includes at least one swing arm which is disposed in at least one of the first engagement portion and the second engagement portion for driving the at least one of the first engagement portion and the second engagement portion to move toward or away from the other. The positioning portion performs as a massaging portion made of a flexible material. The driving member is provided in the positioning portion to drive the positioning portion to move or to vibrate.

In one aspect, the massager can provide clamping massage and stimulation to the part of the human body, especially to the C spot (clitoris) of the woman or penis of the man, through the first and second engagement portions, thereby improving the sex life of the woman or the man. In another aspect, the massager can be positioned during use through the positioning portion, preventing the massager from falling off during use and providing a good user experience. In yet another aspect, the positioning portion can perform as a massaging portion to massage one more portion of human.

### BRIEF DESCRIPTION OF DRAWINGS

The accompanying drawings, which are incorporated in and constitute a part of this specification, illustrate several embodiments of the present disclosure and together with the description, serve to explain the principles of the present disclosure.

FIG. 1 is a perspective view of a massager according to a first embodiment of the present disclosure;

FIG. 2 is another perspective view of the massager shown in FIG. 1;

FIG. 3 is a cross-sectional view of the massager shown in FIG. 1;

FIG. 4 is an exploded view of the massager shown in FIG. 1;

FIG. 5 is an exploded view of an inner housing of the massager shown in FIG. 4;

FIG. 6 is a side view of a driving mechanism in the inner housing shown in FIG. 5;

FIG. 7 is an exploded view of the driving mechanism in the inner housing shown in FIG. 5;

FIG. 8 is a perspective view of an eccentric wheel of the driving mechanism shown in FIG. 7;

FIG. 9 is an exploded view of a driving source of the driving mechanism shown in FIG. 7;

FIG. 10 is a perspective view of a massager according to a second embodiment of the present disclosure;

FIG. 11 is a cross-sectional view of a massager shown in FIG. 10;

FIG. 12 is an exploded view of the massager shown in FIG. 10;

FIG. 13 is a perspective view of the driving mechanism of the massager shown in FIG. 10.

FIG. 14 is an exploded view of the driving mechanism shown in FIG. 13 viewing in one angle;

FIG. 15 is an exploded view of the driving mechanism shown in FIG. 13 viewing in another angle;

FIG. 16 is a perspective view of a massager according to a third embodiment of the present disclosure;

FIG. 17 is a cross-sectional view of the massager shown in FIG. 16;

FIG. 18 is a front view of the massager shown in FIG. 16;

FIG. 19 is an exploded view of the massager shown in FIG. 16;

FIG. 20 is a perspective view of the driving mechanism of the massager shown in FIG. 16.

FIG. 21 is a perspective view of a massager according to a fourth embodiment of the present disclosure;

FIG. 22 is a cross-sectional view of the massager shown in FIG. 21;

FIG. 23 is an exploded view of the massager shown in FIG. 21 viewing in one angle;

FIG. 24 is an exploded view of t massager shown in FIG. 21 viewing in one angle;

FIG. 25 is an exploded view of the driving mechanism shown in FIG. 21 viewing in one angle;

FIG. 26 is an exploded view of the driving mechanism shown in FIG. 21 viewing in another angle;

FIG. 27 is an exploded view of the driving module shown in FIG. 21 viewing in one angle;

FIG. 28 is an exploded view of the driving module shown in FIG. 21 viewing in another angle;

FIG. 29 is a perspective view of the massager according to a fifth embodiment of the present disclosure;

FIG. 30 is a cross-sectional view of the massager shown in FIG. 29;

FIG. 31 is an exploded view of the massager shown in FIG. 29; and

FIG. 32 is a view showing a driving mechanism of the massager shown in FIG. 29.

### DESCRIPTION OF EMBODIMENTS

Reference throughout this specification to “one embodiment”, “an embodiment”, “some embodiments”, “embodiments”, or similar language means that a particular feature, structure, or characteristic described in connection with the embodiment is included in at least one embodiment of the present disclosure. Thus, appearances of the phrases “in one embodiment”, “in an embodiment”, “in some embodiments”, “in embodiments” and similar language throughout this specification may, but do not necessarily, all refer to the same embodiment.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise.

Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, components, and/or groups thereof.

For the purposes of disclosure, the word “substantially” is defined as “for the most part”, it means “to a great extent”, but having some room for some minor variation.

Moreover, the described features, structures, or characteristics of the disclosure may be combined in any suitable manner in one or more embodiments. Features, structures, or characteristics of one embodiment can be mixed and matched with features, structures, or characteristics of another embodiment. It will be apparent to those skilled in the art that various modifications and variations can be made to the present disclosure without departing from the spirit and scope and purpose of the disclosure. Thus, it is intended that the present disclosure cover the modifications and variations of this disclosure provided they come within the scope of the appended claims and their equivalents. Reference will now be made in detail to the preferred embodiments of the disclosure.

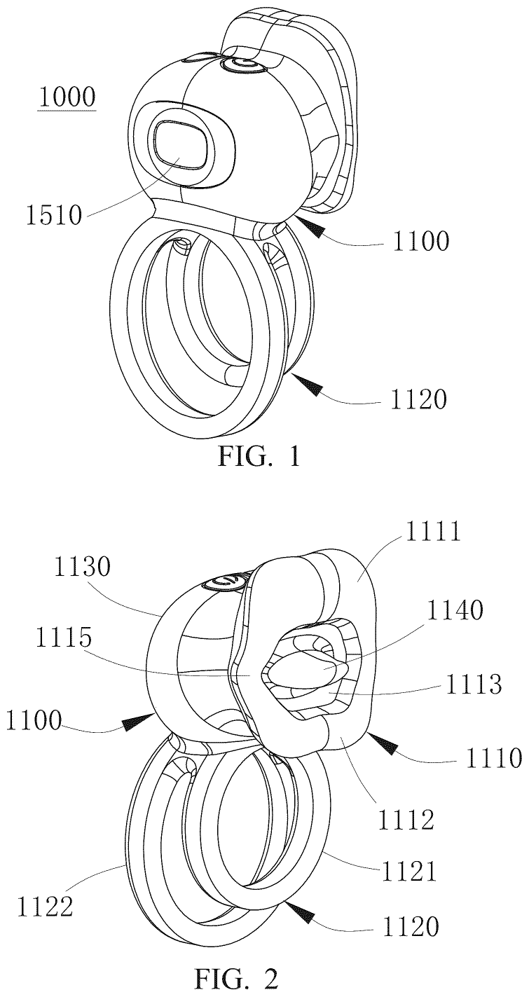

Referring to FIGS. 1 to 3, a massager 1000 according to a first embodiment of the present disclosure includes an outer housing 1100 and a driving mechanism 1200 accommodated in the outer housing 1100. The outer housing 1100 includes a clamping part 1110 and a positioning portion 1120. The clamping part 1110 includes a first engagement portion 1111 and a second engagement portion 1112 that are opposite to each other. There is a cavity 1113 between the first engagement portion 1111 and the second engagement portion 1112. The first engagement portion 1111 and the second engagement portion 1112 are made of a flexible material. In this embodiment, the positioning portion 1120 includes a first ring 1121 and a second ring 1122. The driving mechanism 1200 includes at least one swing arm. The at least one swing arm is disposed in at least one of the first engagement portion 1111 and the second engagement portion 1112 and is configured to drive the at least one of the first engagement portion 1111 and the second engagement portion 1112 to move toward or away from the other.

When the massager 1000 according to this embodiment is in use, it can not only provide clamping massage and stimulation to the part of the human body, especially to the C spot (clitoris) of the woman, by driving the at least one of the first engagement portion 1111 and the second engagement portion 1112 to move toward or away from the other, simulating a mouth of a human, through the at least one swing arm of the driving mechanism 1200, but can also be positioned through the first ring 1121 and the second ring 1122, preventing the massager 1000 from falling off during use and providing a good user experience. In particular, in this embodiment, the first ring 1121 and the second ring 1122 can be disposed around the penis and the pair of testicles of the man, respectively, to enhance the erection. That is, by using the massager 1000 according to this embodiment, the C spot (clitoris) of the woman, the penis and the testicles of the man can be stimulated simultaneously, thereby improving the sex life of both the man and the woman.

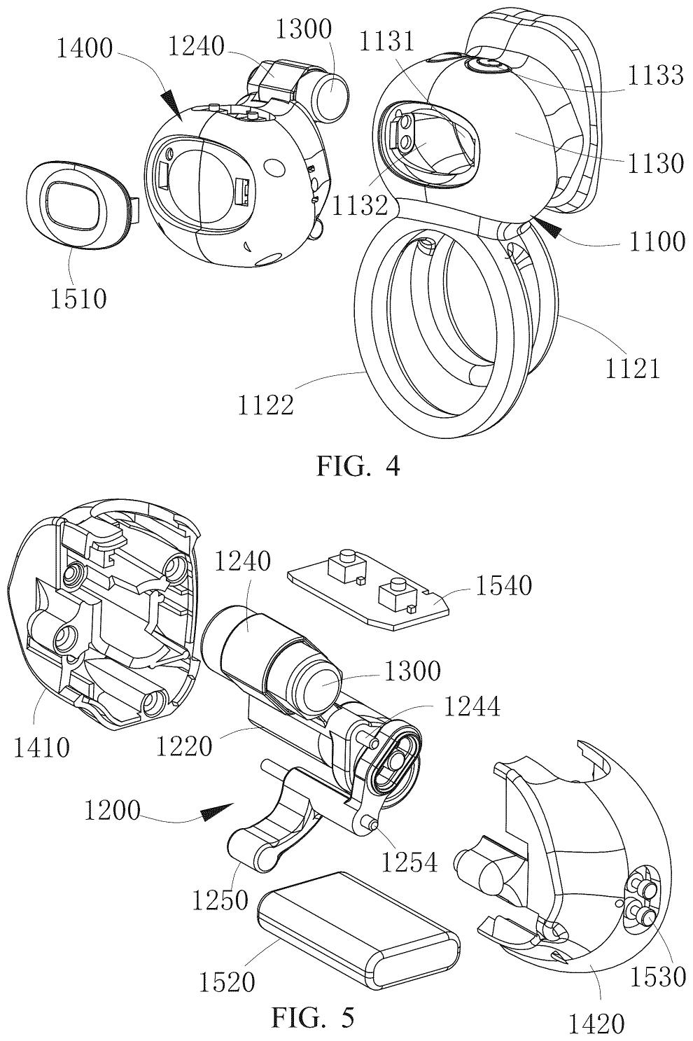

Specifically, referring to FIGS. 2 to 4, in this embodiment, in addition to the clamping part 1110 and the positioning portion 1120, the outer housing 1100 further includes a main body 1130 for connecting the clamping part 1110 and the positioning portion 1120. The main body 1130 is also preferably made of a flexible material. In this embodiment, the main body 1130 is generally elliptical and has a main chamber 1131 therein.

In this embodiment, the first engagement portion 1111 and the second engagement portion 1112 are provided on the front side of the main body 1130 and arranged at an angle relative to one another. The first engagement portion 1111 and the second engagement portion 1112 respectively have a first accommodation chamber 1114 and a second accommodation chamber 1115. The first accommodation chamber 1114 and the second accommodation chamber 1115 are both communicated with the main chamber 1131. Preferably, two ends of the first engagement portion 1111 are respectively connected to two ends of the second engagement portion 1112 to form two connection portions 1115. Each connection portion 1116 is V-shaped, and the first engagement portion 1111 and the second engagement portion 1112 enclose the cavity 1113.

Optionally, the outer housing 1100 further includes a protrusion 1140, and the protrusion 1140 is also made of a flexible material. The protrusion 1140 is located in the cavity 1113 and between the first engagement portion 1111 and the second engagement portion 1112. In use, the protrusion 1140, like a tongue of a human, can also stimulate the C spot (clitoris) of the woman.

Preferably, the massager 1000 further includes at least one vibration member 1300 provided in at least one of the first engagement portion 1111, the second engagement portion 1112 and the protrusion 1140. As shown in the figure, in this embodiment, the massager 1000 includes a vibration member 1300 disposed in the first engagement portion 1111. Therefore, when the first engagement portion 1111 and the second engagement portion 1112 stimulate the C spot (clitoris) of the woman, the first engagement portion 1111 also vibrates, which improves the massage and stimulation effect. The vibration member 1300 is preferably a vibration motor. It can be appreciated that in other embodiments, the vibration member 1300 can be provided in the second engagement portion 1112 or the protrusion 1140. Alternatively, any two of the first engagement portion 1111, the second engagement portion 1112 and the protrusion 1140 can be provided with vibration members 1300. Alternatively, each of the first engagement portion 1111, the second engagement portion 1112 and the protrusion 1140 can be provided with a vibration member 1300.

In this embodiment, the first ring 1121 and the second ring 1122 are provided on the lower side of the main body 1130. The central axis L1 of the first ring 1121 and the central axis L2 of the second ring 1122 are parallel to each other and parallel to the central axis L3 of the cavity 1113. In this embodiment, the first ring 1121 and the second ring 1122 are both formed as complete rings. That is, both the first ring 1121 and the second ring 1122 extend by 360°. The inner diameter of the first ring 1121 is smaller than the inner diameter of the second ring 1122. Optionally, the inner diameter of the first ring 1121 or the inner diameter of the second ring 1122 is in the range of 5-100 mm.

Alternatively, in other embodiments, the positioning portion 1120 can include more or less rings, such as one, three, four rings, or the like. In other embodiments, the ring is not limited to forming as a complete ring. For example, it can be formed into a semicircle or an arc, as long as it has a through hole through which the penis or the testicles of the man can pass. In addition, the ring is not limited to being arranged so that its central axis is parallel to the central axis L3 of the cavity 1113 as shown in the figure. In other embodiments, the central axis of the ring may be perpendicular to or at other angles to the central axis L3 of the cavity 1113. In the case where the positioning portion 1120 includes a plurality of rings, the plurality of rings are not limited to being arranged so that the central axes of the plurality of rings are parallel to each other as shown in the figure, but may be arranged at an angle/angles relative to each other.

Preferably, the outer housing 1100 is formed in one piece made of a flexible material, preferably silicone. That is, the clamping part 1110, the positioning portion 1120, the main portion 1130 and the protrusion 1140 are formed in one piece.

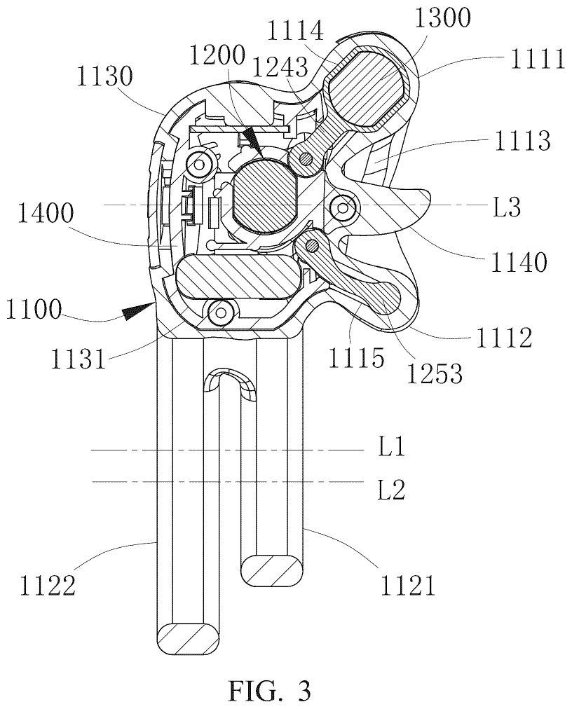

In order to facilitate the installation of the driving mechanism 1200 and other components of the massager 1000, referring to FIGS. 3 to 5, in this embodiment, the massager 1000 further includes an inner housing 1400 made of a rigid material, for example a rigid plastic. The inner housing 1400 is received in the main chamber 1131 of the outer housing 1100. Optionally, the massager 1000 further includes a cover 1510 that snaps with the inner housing 1400 and covers the opening 1132 of the main chamber 1131. In this embodiment, the inner housing 1400 includes a first housing half 1410 and a second housing half 1420 that are detachably connected with each other. The first housing half 1410 and the second housing half 1420 define a plurality of installation chambers for installing the driving mechanism 1200, a battery 1520 for powering the driving mechanism 1200, a first circuit board 1530 electrically connected to the battery 1520, and a second circuit board 1540 electrically connected to the driving mechanism 1200 for controlling the driving mechanism 1200. The second circuit board 1540 cooperates with a key portion 1133 on the main body 1130 so that the operator can operate the massager 1000.

Referring to FIGS. 5 to 7, in this embodiment, the driving mechanism 1200 includes a driving source 1220, an eccentric wheel 1230 connected to a driving shaft 1221 of the driving source 1220, and a first swing member 1240 and a second swing member 1250 that are connected to the eccentric wheel 1230. The first swing member 1240 and the second swing member 1250 are arranged at an angle relative to one another.

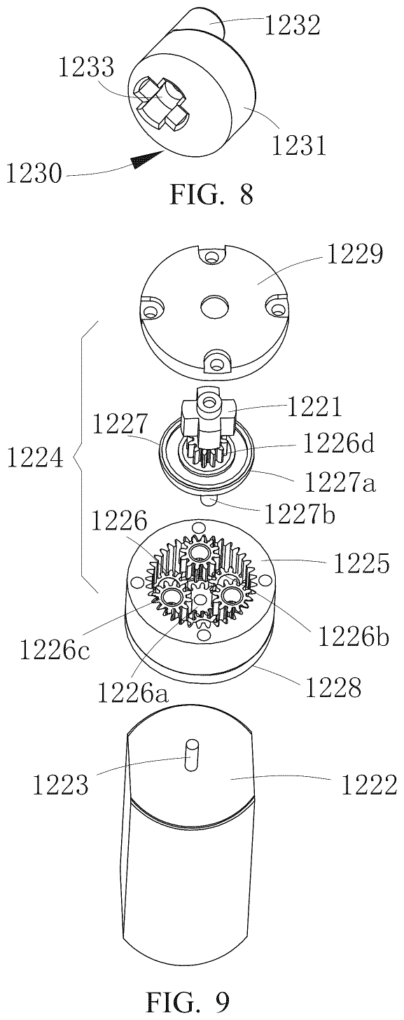

As shown in FIG. 8, in this embodiment, the eccentric wheel 1230 includes a first wheel 1231 and a second wheel 1232. An eccentric connection hole 1233 is defined in one side of the first wheel 1231 for connecting with the driving shaft 1221 of the driving source 1220. As shown in the figure, in this embodiment, the connection hole 1233 is a plum blossom-shaped hole. Correspondingly, the driving shaft 1221 is also plum blossom-shaped. Therefore, the driving shaft 1221 of the driving source 1220 and the eccentric wheel 1230 are prevented from rotating relative to each other, so that the eccentric wheel 1230 can rotate synchronously with the driving shaft 1221. The second wheel 1232 is eccentrically located at the other side of the first wheel 1231.

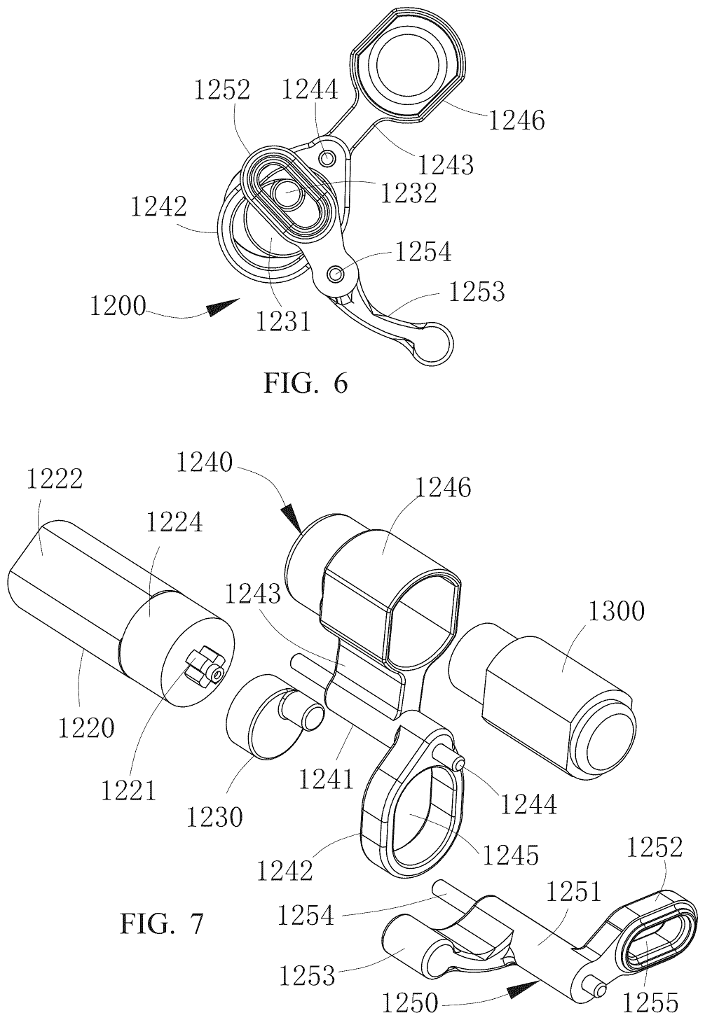

Referring again to FIGS. 6 and 7, in this embodiment, the first swing member 1240 includes a first mounting post 1241, a first collar 1242 and a first swing arm 1243 respectively connected to two sides of the first mounting post 1241. The first mounting post 1241 is rotatably supported in the inner housing 1400 through a first rotation shaft 1244. The first collar 1242 has a first slide groove 1245 so that it can be arranged around the first wheel 1231, and the first wheel 1231 is slidably received in the first slide groove 1245. The first swing arm 1243 extends out of the inner housing 1400 and has a receiving sleeve 1246 for receiving the vibration member 1300.

The second swing member 1250 includes a second mounting post 1251, a second collar 1252 and a second swing arm 1253 respectively connected to two sides of the second mounting post 1251. The second mounting post 1251 is rotatably supported in the inner housing 1400 through a second rotation shaft 1254. The second collar 1252 has a second slide groove 1255 so that it can be arranged around the second wheel 1232, and the second wheel 1232 is slidably received in the second slide groove 1255. The second swing arm 1253 extends out of the inner housing 1400.

In other words, in this embodiment, the at least one swing arm includes the first swing arm 1243 and the second swing arm 1253. As shown in FIG. 3, the first swing arm 1243 extending out of the inner housing 1400 is received in the first accommodation chamber 1114 of the first engagement portion 1111 and supports the first engagement portion 1111. The second swing arm 1253 extending out of the inner housing 1400 is received in the second accommodation chamber 1115 of the second engagement portion 1112 and supports the second engagement portion 1112. When the driving source 1220 works, the driving shaft 1221 of the driving source 1220 rotates, and the eccentric wheel 1230 is driven to rotate by the driving shaft 1221. The eccentric wheel 1230 drives the first swing member 1240 and the second swing member 1250 to swing around the first rotation shaft 1244 and the second rotation shaft 1254 respectively, so the first swing arm 1243 and the second swing arm 1253 will respectively drive the first engagement portion 1111 and the second engagement portion 1112 to move toward or away from each other simultaneously, thereby realizing clamping massage.

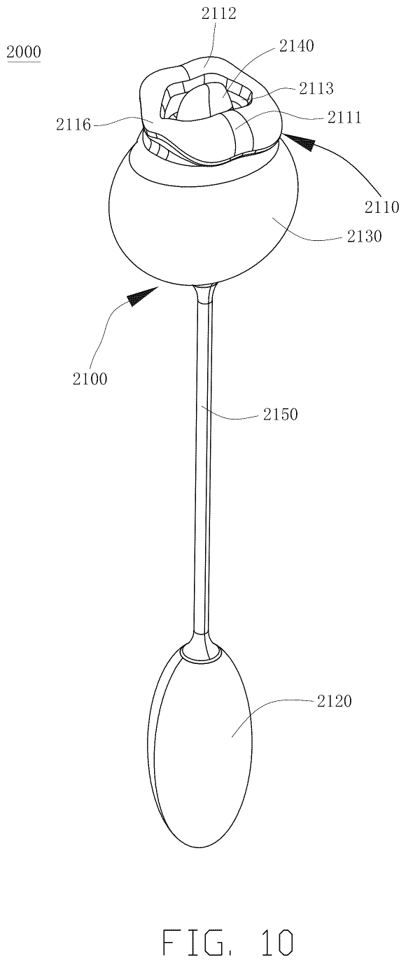

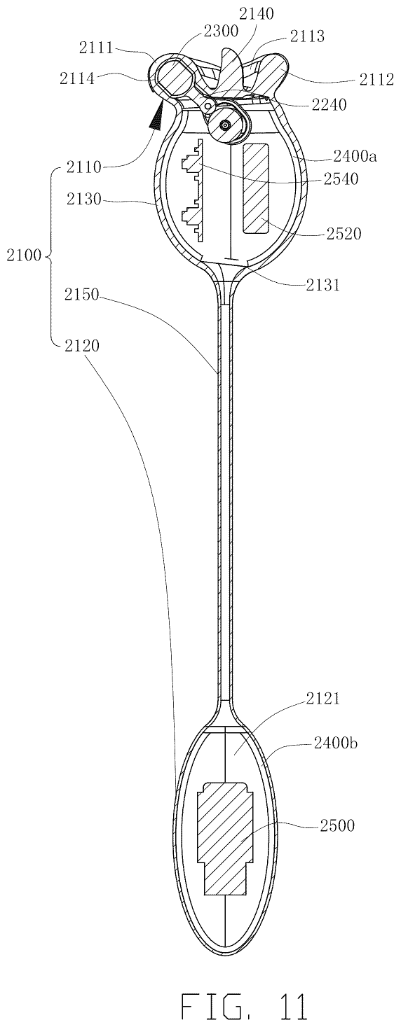

Referring to FIG. 9, in this embodiment, the driving source 1220 preferably includes a motor 1222 and a reduction gearbox 1224 connected to the output shaft 1223 of the motor 1222. The driving shaft 1221 of the driving source 1220 is provided by the reduction gearbox 1224. Therefore, the rotation speed of the driving shaft 1221 of the driving source 1220 is smaller than the rotation speed of the output shaft 1223 of the motor 1222, and thus the swing frequency of the first swing arm 1243 and the second swing arm 1253 is also small, improving the massage comfort.

As an example, the reduction gearbox 1224 includes an inner gear ring 1225, a plurality of gears 1226 accommodated in the inner gear ring 1225, a rotation frame 1227 that cooperates with the plurality of gears 1226, and a bottom plate 1228 and a top plate 1229 respectively covering two ends the inner gear ring 1225. The plurality of gears 1226 include a first sun gear 1226a close to the base plate 1228 and connected to the output shaft 1223 of the motor 1222, and a plurality of first planetary gears 1226b (here, three first planetary gears 1226) meshed with the first sun gear 1226a and the inner gear ring 1225, a plurality of second planetary gears 1226c (here, three second planetary gears 1226c) meshed with the inner gear ring 1225 and close to the top plate 1229, and a second sun gear 1226d meshed with the plurality of second planetary gears 1226c and close to the top plate 1229.

The rotation frame 1227 includes a partition plate 1227a and a plurality of connection shafts 1227b (here, three connection shafts 1227b) connected to the first side of the partition plate 1227a. The partition plate 1227a is located in the inner gear ring 1225 substantially at the axially middle position to divide the internal space of the inner gear ring 1225 into two layers, wherein the first planetary gears 1226b and the first sun gear 1226a are located on the lower layer close to the bottom plate 1228, with the connection shafts 1227b respectively connected to the corresponding first planetary gears 1226b, and the second planetary gears 1226c and the second sun gear 1226d are located on the upper layer close to the top plate 1229. In this embodiment, the driving shaft 1221 is coaxially connected to the second sun gear 1226d and is located outside the top plate 1229.

The above driving source 1220 is only shown as an example. In other embodiments, the driving source 1220 may use other configurations, which will not be described again here.

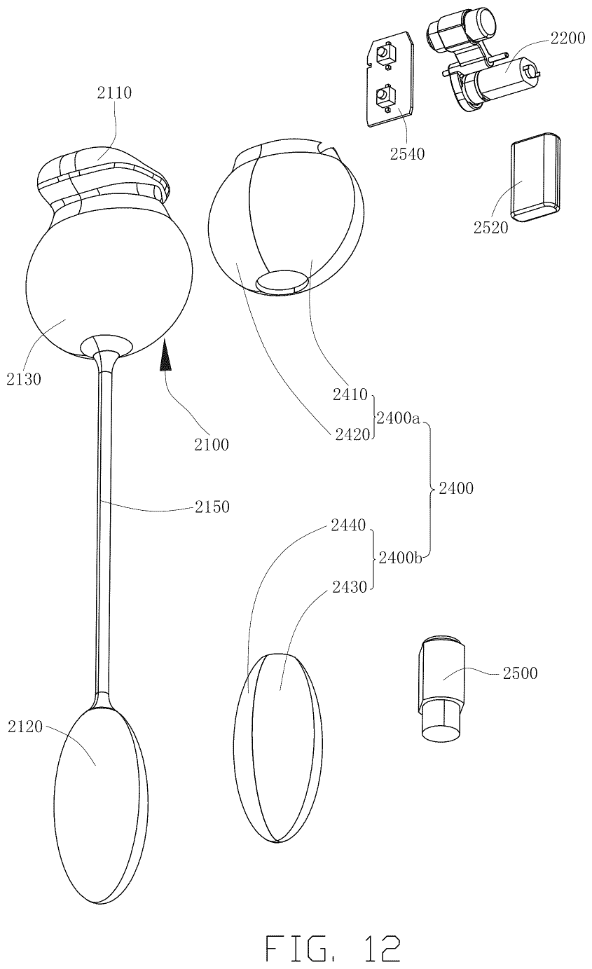

Referring to FIGS. 10 and 15, the massager 2000 according to a second embodiment of the present disclosure is substantially the same as the massager 1000 according to the first embodiment, and the similarities therebetween will not be repeated here again. The massager 2000 according to the second embodiment of the present disclosure also includes an outer housing 2100 and a driving mechanism 2200 accommodated in the outer housing 2100. The outer housing 2100 includes a clamping part 2110 and a positioning portion 2120. The clamping part 2110 includes a first engagement portion 2111 and a second engagement portion 2112 that are opposite to each other. There is a cavity 2113 between the first engagement portion 2111 and the second engagement portion 2112. The first engagement portion 2111 and the second engagement portion 2112 are made of a flexible material. A tongue-like protrusion 2140 is provided in the cavity 2113. The main difference between them is that the driving mechanism 2200 of the massager 2000 according to the second embodiment includes a first swing member 2240 and no longer includes a second swing member. Further, the positioning portion 2120 of the massager 2000 according to the second embodiment is also different from the positioning portion 1120 according to the first embodiment. The driving mechanism 2200 includes at least one swing arm. The at least one swing arm is disposed in at least one of the first engagement portion 2111 and the second engagement portion 2112 and is configured to drive the at least one of the first engagement portion 2111 and the second engagement portion 2112 to move toward or away from the other.

Specifically, in this embodiment, in addition to the clamping part 2110 and the positioning portion 2120, the outer housing 2100 further includes a main body 2130. The clamping part 2110 is connected to the main body 2130. The main body 2130 is also preferably made of a flexible material. In this embodiment, the main body 2130 is generally elliptical and has a main chamber 2131 therein. In this embodiment, the clamping part 2110 is arranged at a top portion of the main body 2130.

In this embodiment, referring to FIG. 10 and FIG. 11, the first engagement portion 2111 and the second engagement portion 2112 are provided on the front side of the main body 2130 and arranged at an angle relative to one another. The first engagement portion 2111 has a accommodation chamber 2114. The accommodation chamber 2114 is communicated with the main chamber 2131. Preferably, two ends of the first engagement portion 2111 are respectively connected to two ends of the second engagement portion 2112 to form two connection portions 2115. Each connection portion 2116 is V-shaped, and the first engagement portion 2111 and the second engagement portion 2112 enclose the cavity 2113.

Optionally, the protrusion 2140 is also made of a flexible material. The protrusion 2140 is located in the cavity 2113 and between the first engagement portion 2111 and the second engagement portion 2112. In use, the protrusion 2140, like a tongue of a human, can also stimulate the C spot (clitoris) of the woman.

Preferably, the massager 2000 further includes at least one first vibration member 2300 provided in at least one of the first engagement portion 2111, the second engagement portion 2112 and the protrusion 2140. As shown in the figure, in this embodiment, the massager 2000 includes a first vibration member 2300 disposed in the first engagement portion 2111. Therefore, when the first engagement portion 2111 and the second engagement portion 2112 stimulate the C spot (clitoris) of the woman, the first engagement portion 2111 also vibrates, which improves the massage and stimulation effect. The first vibration member 2300 is preferably a vibration motor. It can be appreciated that in other embodiments, the vibration member 2300 can be provided in the second engagement portion 2112 or the protrusion 2140. Alternatively, any two of the first engagement portion 2111, the second engagement portion 2112 and the protrusion 1140 can be provided with the first vibration members 2300. Alternatively, each of the first engagement portion 2111, the second engagement portion 2112 and the protrusion 2140 can be provided with a first vibration member 2300.

Preferably, the outer housing 2100 is formed in one piece made of a flexible material, preferably silicone. That is, the clamping part 2110, the positioning portion 2120, the main portion 2130 and the protrusion 2140 are formed in one piece.

In this embodiment, the massager 2000 further includes an inner housing 2400 made of a rigid material, for example a rigid plastic. The inner housing 2400 includes a first inner housing portion 2400a received in the main chamber 2131 of the outer housing 2100. In this embodiment, the first inner housing portion 2400a includes a first housing half 2410 and a second housing half 2420 that are detachably connected with each other. The first housing half 2410 and the second housing half 2420 define a plurality of installation chambers for installing the driving mechanism 2200, a battery 2520 for powering the driving mechanism 2200, a first circuit board 2530 electrically connected to the battery 2520, and a second circuit board 2540 electrically connected to the driving mechanism 2200 for controlling the driving mechanism 2200. The second circuit board 2540 cooperates with a key portion (not shown) on the main body 2130 so that the operator can operate the massager 2000.

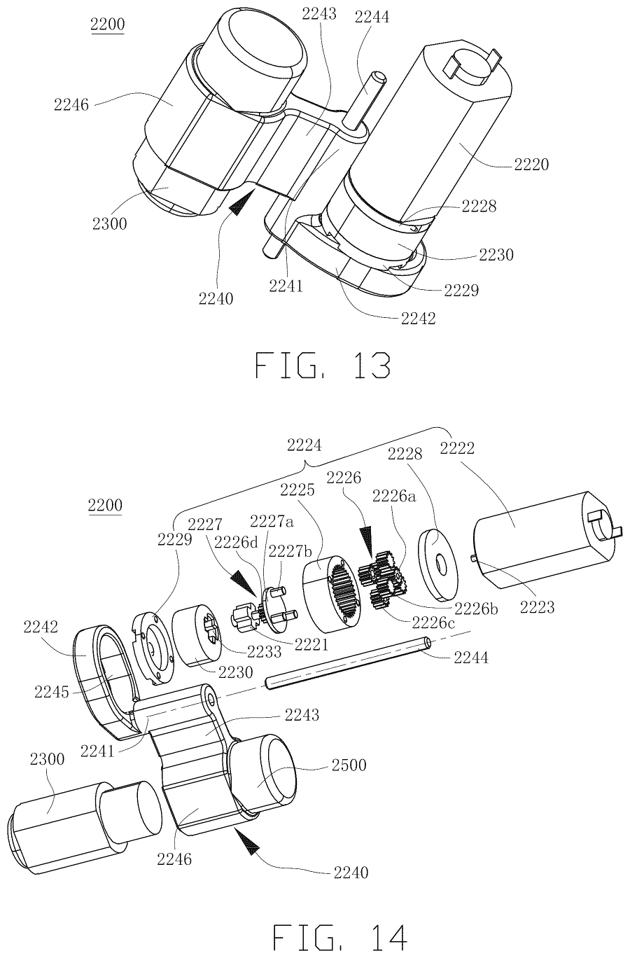

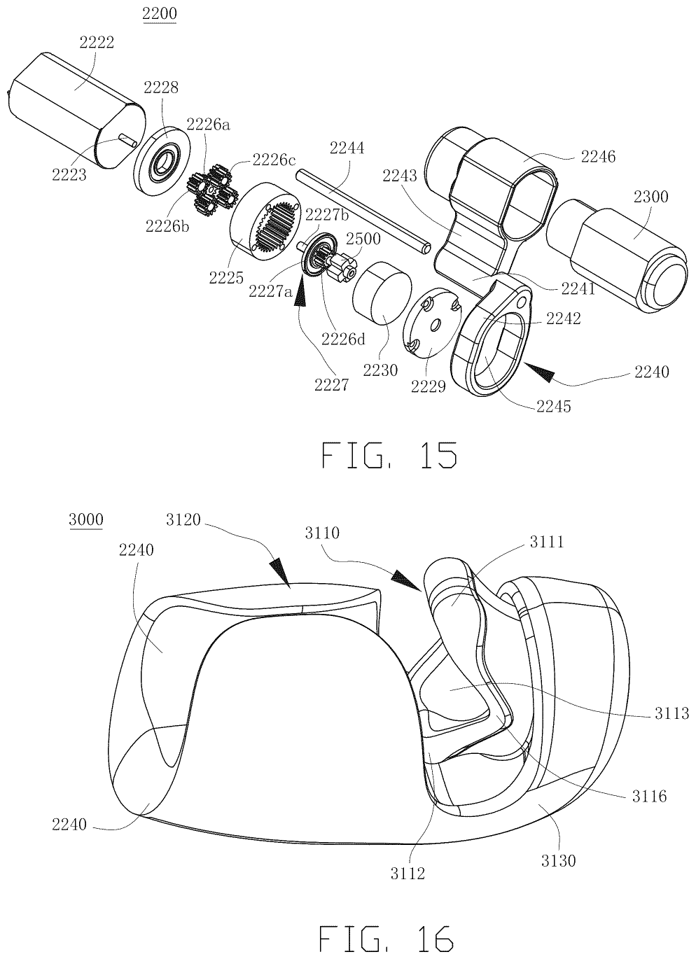

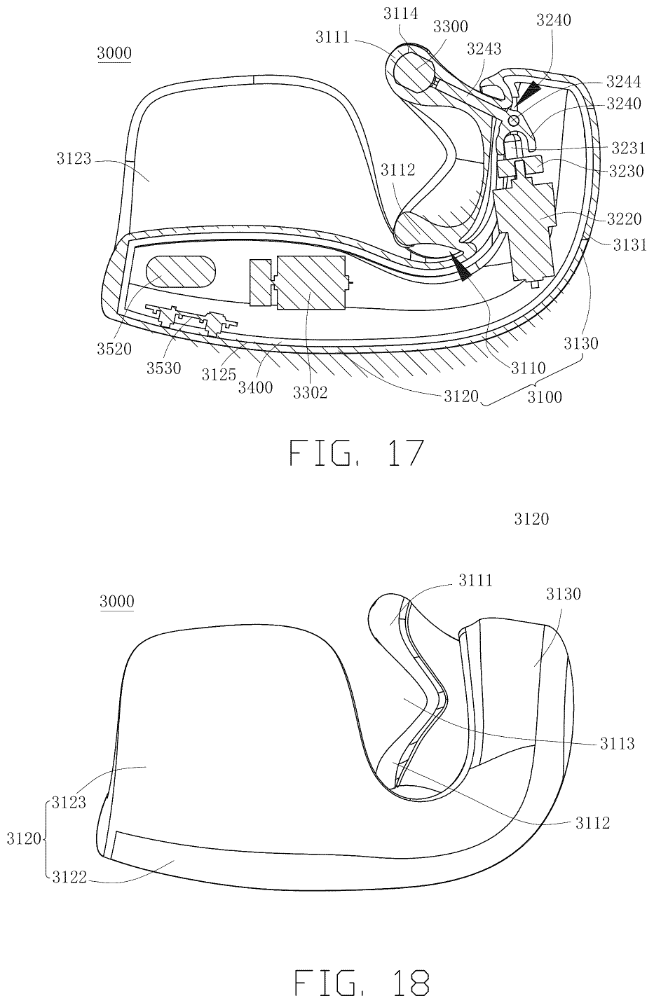

Referring to FIGS. 13 to 15, in this embodiment, the driving mechanism 2200 includes a driving source 2220, an eccentric wheel 2230 connected to a driving shaft 2221 of the driving source 2220, and a swing member 2240 that is connected to the eccentric wheel 2230.

In this embodiment, an eccentric connection hole 2233 is defined in one side of the eccentric wheel 2230 for connecting with the driving shaft 2221 of the driving source 2220. As shown in the figure, in this embodiment, the connection hole 2233 is a plum blossom-shaped hole. Correspondingly, the driving shaft 2221 is also plum blossom-shaped. Therefore, the driving shaft 2221 of the driving source 2220 and the eccentric wheel 2230 are prevented from rotating relative to each other, so that the eccentric wheel 2230 can rotate synchronously with the driving shaft 2221.

In this embodiment, the swing member 2240 includes a mounting post 2241, a collar 2242 and a swing arm 2243 respectively connected to two sides of the mounting post 2241. The mounting post 2241 is rotatably supported in the inner housing 2400 through a rotation shaft 2244. The collar 2242 has a slide groove 2245 so that it can be arranged around the eccentric wheel 2230, and the eccentric wheel 2230 is slidably received in the slide groove 2245. The swing arm 2243 extends out of the inner housing 2400 and has a receiving sleeve 2246 for receiving the first vibration member 2300.

In other words, in this embodiment, the at least one swing arm includes the swing arm 2243. The swing arm 2243 extending out of the inner housing 2400 is received in the accommodation chamber 2114 of the engagement portion 2111 and supports the first engagement portion 2111. When the driving source 2220 works, the driving shaft 2221 of the driving source 2220 rotates, and the eccentric wheel 2230 is driven to rotate by the driving shaft 2221. The eccentric wheel 2230 drives the swing member 2240 to swing around the rotation shaft 2244, so the swing arm 2243 will drive the engagement portion 2111 to move toward or away from the second engagement portion 2112, thereby realizing clamping massage.

In this embodiment, the driving source 2220 preferably includes a motor 2222 and a reduction gearbox 2224 connected to the output shaft 2223 of the motor 2222. The driving shaft 2221 of the driving source 2220 is provided by the reduction gearbox 2224. Therefore, the rotation speed of the driving shaft 2221 of the driving source 2220 is smaller than the rotation speed of the output shaft 2223 of the motor 2222, and thus the swing frequency of the swing arm 2243 is also small, improving the massage comfort.

As an example, the reduction gearbox 2224 includes an inner gear ring 2225, a plurality of gears 2226 accommodated in the inner gear ring 2225, a rotation frame 2227 that cooperates with the plurality of gears 2226, and a bottom plate 2228 and a top plate 2229 respectively covering two ends the inner gear ring 2225. The plurality of gears 2226 include a first sun gear 2226a close to the base plate 2228 and connected to the output shaft 2223 of the motor 2222, and a plurality of first planetary gears 2226b (here, three first planetary gears 2226b) meshed with the first sun gear 2226a and the inner gear ring 2225, a plurality of second planetary gears 2226c (here, three second planetary gears 2226c) meshed with the inner gear ring 2225 and close to the top plate 2229, and a second sun gear 2226d meshed with the plurality of second planetary gears 2226c and close to the top plate 2229.

The rotation frame 2227 includes a partition plate 2227a and a plurality of connection shafts 2227b (here, three connection shafts 2227b) connected to the first side of the partition plate 2227a. The partition plate 2227a is located in the inner gear ring 2225 substantially at the axially middle position to divide the internal space of the inner gear ring 2225 into two layers, wherein the first planetary gears 2226b and the first sun gear 2226a are located on the lower layer close to the bottom plate 2228, with the connection shafts 2227b respectively connected to the corresponding first planetary gears 2226b, and the second planetary gears 2226c and the second sun gear 2226d are located on the upper layer close to the top plate 2229. In this embodiment, the driving shaft 2221 is coaxially connected to the second sun gear 2226d and is located outside the top plate 2229.

The above driving source 2220 is only shown as an example. In other embodiments, the driving source 2220 may use other configurations, which will not be described again here.

In this embodiment, the position portion 2120 of the massager 2000 according to the second embodiment performs as a massaging portion. The massaging portion is ellipsoid. The massager 2000 further includes a second vibration member 2500 provided in the massaging portion. The second vibration member 2500 is also preferably a vibration motor to perform vibration massage on the vagina or the rectum to improve the massage effect. The second vibration member 2500 may be electrically connected to the battery 2520 and powered by the battery 2520. It should be understood that the massaging portion may be other shapes such as a sphere, a cylinder or a general cylinder.

In the embodiment, referring to FIGS. 10 to 12, the outer housing 2100 further includes a connecting portion 2150 disposed between the main body 2130 and the positioning portion 2120. That is, two ends of the connecting portion 2150 are connected to the main body 2130 and the positioning portion 2120 respectively. The connecting portion 2150 is also preferably made of a flexible material. The connecting portion 2150 is hollow. A cable for connecting the second vibration member 2500 to the battery 2520 and a cable for connecting the second vibration member 2500 to the second circuit board 2540 are received in the connecting portion 2150. Specifically, the connecting portion 2150 is a long and small cylinder. That is, a length of the connecting portion 2150 is larger than a length of any of the main body 2130 and the positioning portion 2120. Therefore, the clamping part 2110 and the positioning portion 2120 can massage two portions with large distance of human.

Specifically, the connecting portion 2150 is bendable, and a soft tube 2151 is received in the connecting portion 2150. Two ends of the soft tube 2151 are connected to the first inner housing portion 2400a and a second inner housing portion 2400b described below of the inner housing 2400 respectively. The soft tube 2151 enables the connecting portion 2150 to be bendable and movable, so as to fit different orientations and positions of massage demand.

In this embodiment, the massaging portion is hollow and has a massaging cavity 2121 therein. The second vibration member 2500 is accommodated in the massaging cavity 2121. The inner housing 2400 further includes the second inner housing portion 2400b received in the massaging portion of the outer housing 2100. In this embodiment, the second inner housing portion 2400b includes a third housing half 2430 and a fourth housing half 2440 that detachably connected with each other.

Referring to FIGS. 16-20, similar to the massager 1000 according to the first embodiment, the massager 3000 according to a third embodiment of the present disclosure also includes an outer housing 3100 and a driving mechanism 3200 accommodated in the outer housing 3100. The outer housing 3100 includes a clamping part 3110 and a positioning portion 3120. The clamping part 3110 includes a first engagement portion 3111 and a second engagement portion 3112 that are opposite to each other. There is a cavity 3113 between the first engagement portion 3111 and the second engagement portion 3112. In addition, the driving mechanism 3200 of the massager 3000 according to the third embodiment also includes a swing arm and no longer includes a second swing arm, and the outer housing 3100 no longer includes a protrusion. The swing arm is configured to drive the first engagement portion 3111 to move toward or away from the second engagement portion 3112 to achieve clamping massage. However, the specific working principle and structure of the driving mechanism 3200 of the massager 3000 according to the third embodiment are different from those of the driving mechanism 1200 according to the first embodiment, and the positioning portion 3120 of the massager 3000 according to the third embodiment is also different from the positioning portion 1120 according to the first embodiment.

Specifically, referring to FIGS. 16 to 18, in this embodiment, in addition to the clamping part 3110 and the positioning portion 3120, the outer housing 3100 further includes a main body 3130 for connecting the clamping part 3110 and the positioning portion 3120. The main body 3130 is also preferably made of a flexible material. In this embodiment, the main body 3130 is generally a cuboid and has a main chamber 3131 therein. Optionally, the massager 3000 further includes a cover 3510 that snaps with the main body 3130 and covers the opening 3511 of the main body 3130.

In this embodiment, the first engagement portion 3111 and the second engagement portion 3112 are provided on the front side of the main body 3130 and arranged at an angle relative to one another. The first engagement portion 3111 has an accommodation chamber 3114. The accommodation chamber 3114 is communicated with the main chamber 3131. Preferably, two ends of the first engagement portion 3111 are respectively connected to two ends of the second engagement portion 3112 to form two connection portions 3115. Each connection portion 3116 is V-shaped, and the first engagement portion 3111 and the second engagement portion 3112 enclose the cavity 3113.

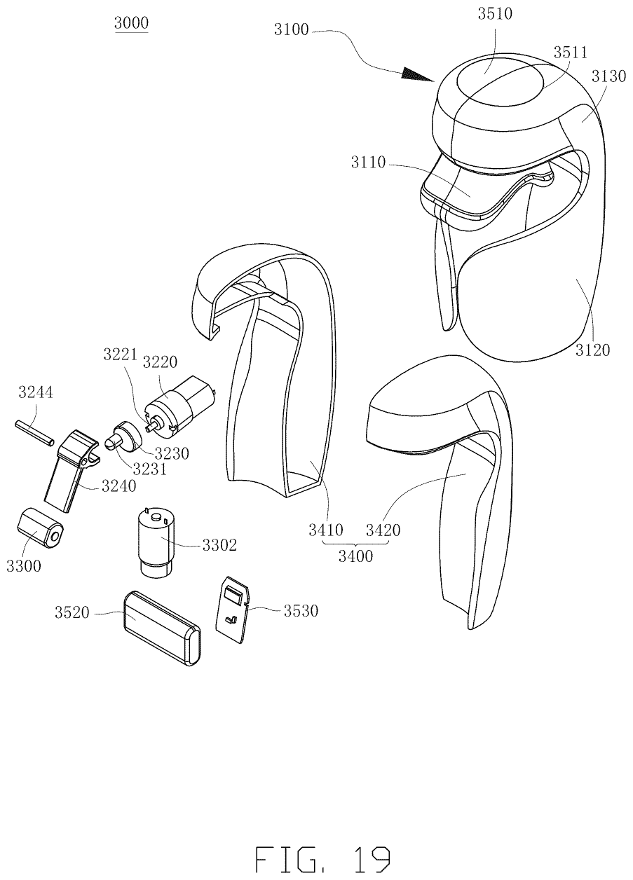

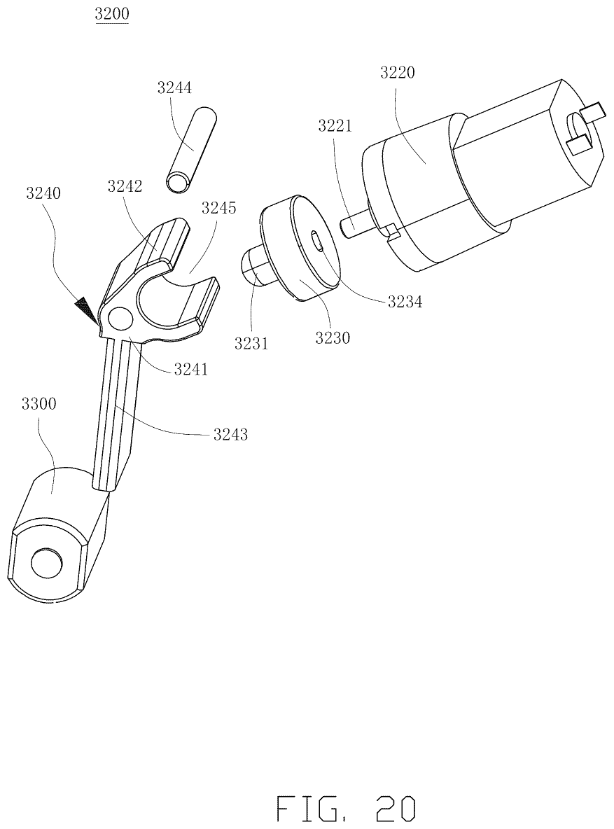

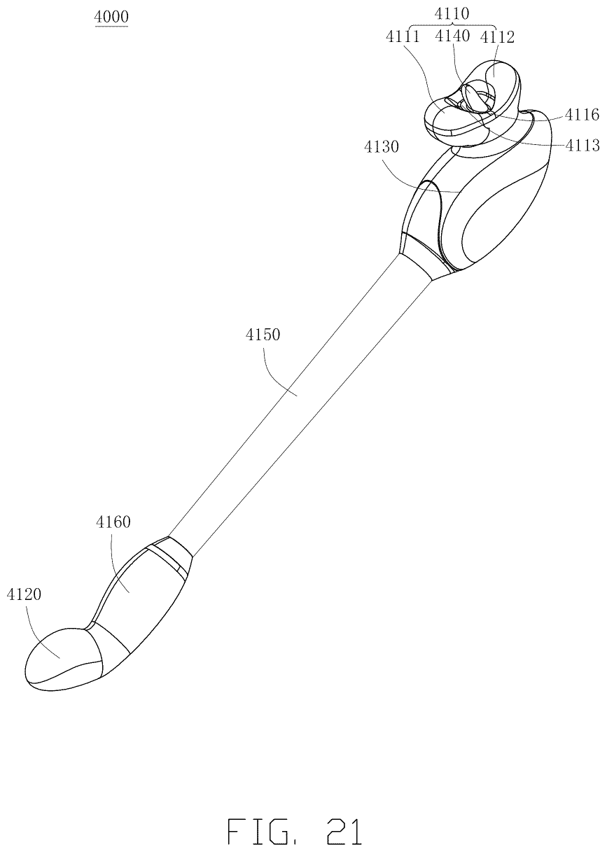

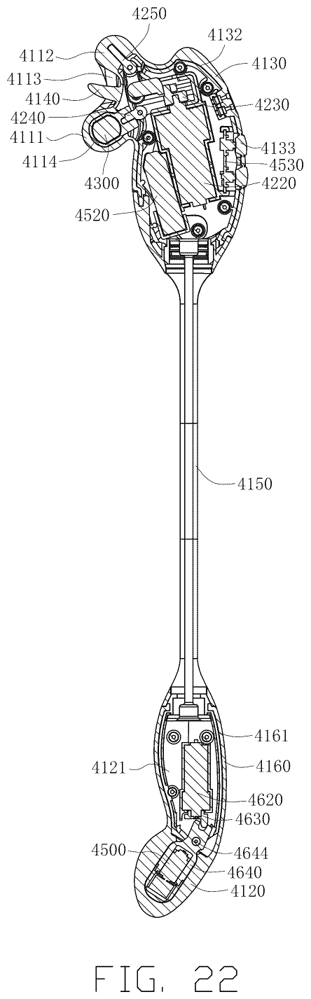

In this embodiment, referring to FIG. 19 and FIG. 20, the driving mechanism 3200 includes a driving source 3220, and eccentric wheel 3230 connected to a driving shaft 3221 of the driving source 3220, and a swing member 3240 that is connected to the eccentric wheel 3230. Specifically, a center connection hole 3234 is defined in one side of the eccentric wheel 3230 for connecting with the driving shaft 3221 of the driving source 3220. Therefore, the driving shaft 3221 of the driving source 3220 and the eccentric wheel 3230 are prevented from rotating relative to each other, so that the eccentric wheel 3230 can rotate synchronously with the driving shaft 3221.

Preferably, the massager 3000 further includes at least one first vibration member 3300 provided in at least one of the first engagement portion 3111, the second engagement portion 3112. As shown in the figure, in this embodiment, the massager 3000 includes a first vibration member 3300 disposed in the first engagement portion 3111. The first vibration member 3300 is preferably a vibration motor. It can be appreciated that in other embodiments, the first vibration member 3300 can be provided in the second engagement portion 3112. Alternatively, the first engagement portion 3111, the second engagement portion 3112 may be provided with the first vibration members 3300. Alternatively, each of the first engagement portion 3111, the second engagement portion 3112 may be provided with a first vibration member 3300.

In this embodiment, the swing member 3240 is rotatably supported in the inner housing 3400 through a rotation shaft 3244. The swing member 3240 includes a base block 3241, two plates 3242 connected to the base block 3241 and a swing arm 3243 connected to the base block 3241. The plates 3242 are separated from each other and opposite to each other, thus defining a swing slot 3245 between the two plates 3242. The swing arm 3243 extends out of the inner housing 3400 and is connected to the first vibration member 3300. The first vibration member 3300 is received in the accommodation chamber 3114 of the first engagement portion 3111. The eccentric wheel 3230 forms an eccentric pole 3231 on one side of the eccentric wheel 3230. The eccentric pole 3231 faces the swing member 3240 and is movably received in the swing slot 3245. An axis of the eccentric pole 3231 and the rotational axis of the eccentric wheel 3230 are offset. During rotation of the eccentric wheel 3230, the eccentric pole 3231 pushes the plates 3242 to drive the swing member 3240 swing around the rotation shaft 3244. The swing arm 3243 is received in an accommodation chamber 3114 of the first engagement portion 3111 and supports the first engagement portion 3111.

As shown in FIGS. 16 to 18, the positioning portion 3120 of the massager 3000 according to the third embodiment performs as a massaging portion and is a general cylindrical sleeve and defines a holding cavity. The positioning portion 3120 includes a base portion 3122 and two side portions 3123 connected to the base portion 3122. A first end of the two side portions 3123 are connected to opposite sides of the base portion 3122 respectively and a second end of the two side portions 3123 extending towards each other, thus defining the holding cavity. Specifically, the massager 3000 according to the third embodiment further includes a second vibration member 3302 accommodated in the base portion 3122 of the positioning portion 3120. The second vibration member 3302 is also preferably a vibration motor to perform vibration massage on the penis to improve the massage effect. During use, a penis of man may be inserted into the positioning portion 3120 and received in the holding cavity, preventing the massager 3000 from falling off and providing a good user experience. Further, the massager 3000 according to the third embodiment cannot only provide clamping massager through the clamping part 3110, but can also massage and stimulate the penis of man through the sleeve-like positioning portion 3120, to improve the sex life of the man.

In this embodiment, the holding cavity faces the cavity 3113 of the clamping part 3110. Specifically, the base portion 3122 is generally perpendicular to the main body 3130, and the side portions 3123 and the main body 3130 are disposed at the same side of the base portion 3122. Specifically, the side portions 3123 are arc-shaped. When the penis of man is inserted into the positioning portion 3120 and clamped by the side portions 3123, an end of the penis is clamped by the first engagement portion 3111 and a second engagement portion 3112.

In this embodiment, the base portion 3122 of the positioning portion 3120 defines a positioning chamber 3125 therein. The positioning chamber 3125 is communicated with the main chamber 3131.

In this embodiment, the massager 3000 further includes an inner housing 3400 made of a rigid material, for example a rigid plastic. The inner housing 3400 is received in the main chamber 3131 and the positioning chamber 3125 of the outer housing 3100. In this embodiment, the inner housing 3400 includes a first housing half 3410 and a second housing half 3420 that are detachably connected with each other. The first housing half 3410 and the second housing half 3420 is configured for installing the driving mechanism 3200, a battery 3520 for powering the driving mechanism 3200, a circuit board 3530 electrically connected to the battery 3520. The circuit board 3530 is electrically connected to the driving mechanism 3200 for controlling the driving mechanism 3200. The circuit board 3530 cooperates with a key portion (not shown) on the positioning portion 3120 so that the operator can operate the massager 3000. In this embodiment, the driving mechanism 3200 is installed in a portion of the inner housing 3400 corresponding to the main body 3130, and the circuit board 3530 and the battery 3520 are installed in the inner housing 3400 corresponding to the base portion 3122 of the positioning portion 3120.

In other embodiments, the driving mechanism 3200 may further include a second swing arm. That is, the second engagement portion 3112 may also be driven to move toward or away from the first engagement portion 3111.

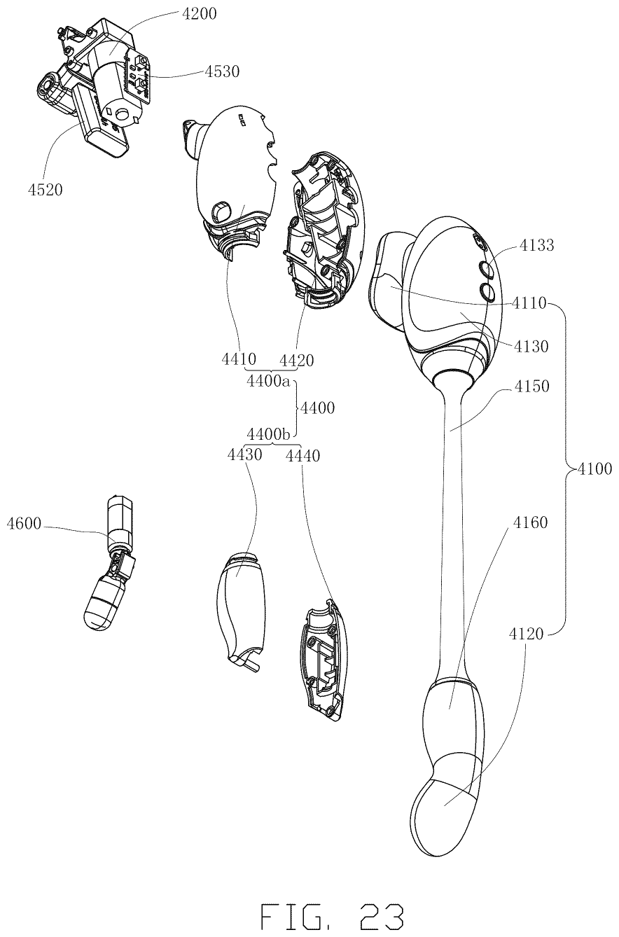

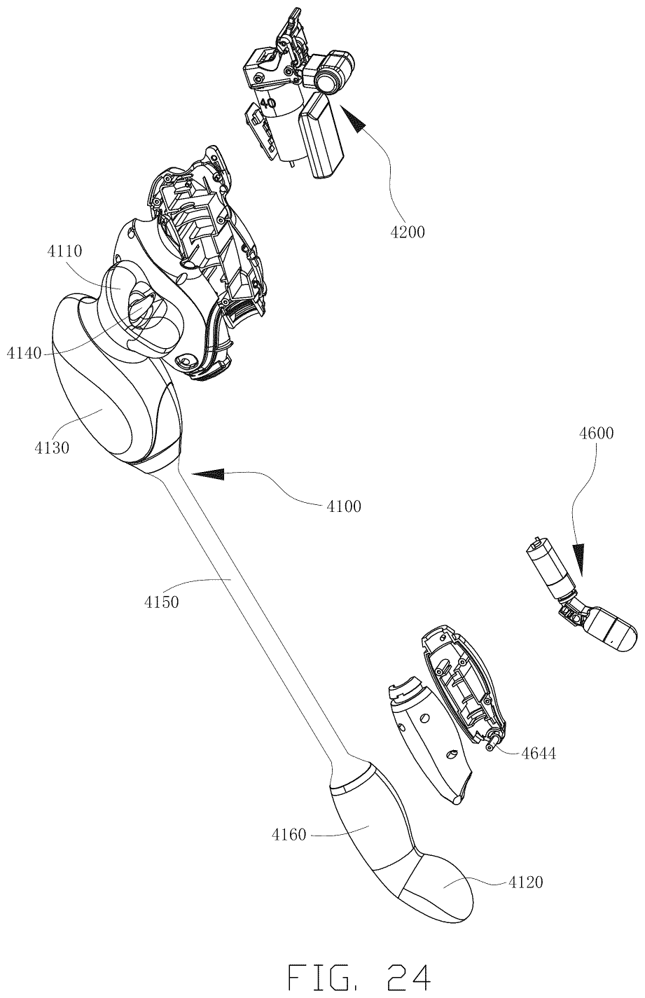

Referring to FIGS. 21-28, a massager 4000 according to a fourth embodiment of the present disclosure includes an outer housing 4100, a driving mechanism 4200 and a driving module 4600. The driving mechanism 4200 and the driving module 4600 are accommodated in the outer housing 4100. The outer housing 4100 includes a clamping part 4110 and a positioning portion 4120. The clamping part 4110 includes a first engagement portion 4111 and a second engagement portion 4112 that are opposite to each other. There is a cavity 4113 between the first engagement portion 4111 and the second engagement portion 4112. The first engagement portion 4111 and the second engagement portion 4112 are made of a flexible material. A tongue-like protrusion 4140 is provided in the cavity 4113. The driving mechanism 4200 includes at least one swing arm. The at least one swing arm is disposed in at least one of the first engagement portion 4111 and the second engagement portion 4112 and is configured to drive the at least one of the first engagement portion 4111 and the second engagement portion 4112 to move toward or away from the other. The positioning portion 4120 performs as a swingable massaging portion driven by the driving module 4600.

Specifically, in this embodiment, referring to the FIG. 21 and the FIG. 22, in addition to the clamping part 4110 and the positioning portion 4120, the outer housing 4100 further includes a first main body 4130 for connecting the clamping part 4110, a second main body 4160 for connecting the positioning portion 4120 and a connecting portion 4150. The first main body 4130, the second main body 4160 and the connecting portion 4150 are also preferably made of a flexible material. In this embodiment, the first main body 4130 is generally elliptical and has a first main chamber 4132 therein, the second main body 4160 is generally cylindric and has a second main chamber 4161 therein, and the connecting portion 4150 is cylindric and hollow. Specifically, the connecting portion 4150 is a long and small cylinder. That is, a length of the connecting portion 4150 is larger than a length of any of the first main body 4130, the positioning portion 4120 and the second main body 4160. Therefore, the clamping part 4110 and the positioning portion 4120 can massage two portions with large distance of human.

Specifically, the connecting portion 4150 is bendable, and a soft tube 4151 is received in the connecting portion 4150. Two ends of the soft tube 4151 are connected to the first inner housing portion 4400a and a second inner housing portion 4400b described below of the inner housing 4400 respectively. The soft tube 4151 enables the connecting portion 4150 to be bendable and movable, so as to fit different orientations and positions of massage demand.

In this embodiment, the first engagement portion 4111 and the second engagement portion 4112 are provided on the front side of the first main body 4130 and arranged at an angle relative to one another. The first engagement portion 4111 and the second engagement portion 4112 respectively have a first accommodation chamber 4114 and a second accommodation chamber 4115. The first accommodation chamber 4114 and the second accommodation chamber 4115 are both communicated with the main chamber 1131. Preferably, two ends of the first engagement portion 4111 are respectively connected to two ends of the second engagement portion 4112 to form two connection portions 4115. Each connection portion 4116 is V-shaped, and the first engagement portion 4111 and the second engagement portion 4112 enclose the cavity 4113.

Optionally, the protrusion 4140 is also made of a flexible material. The protrusion 4140 is located in the cavity 4113 and between the first engagement portion 4111 and the second engagement portion 4112. In use, the protrusion 4140, like a tongue of a human, can also stimulate the C spot (clitoris) of the woman.

Preferably, the massager 4000 further includes at least one first vibration member 4300 provided in at least one of the first engagement portion 4111, the second engagement portion 4112 and the protrusion 4140. As shown in the figure, in this embodiment, the massager 4000 includes a first vibration member 4300 disposed in the first engagement portion 4111. Therefore, when the first engagement portion 4111 and the second engagement portion 4112 stimulate the C spot (clitoris) of the woman, the first engagement portion 4111 also vibrates, which improves the massage and stimulation effect. The first vibration member 4300 is preferably a vibration motor. It can be appreciated that in other embodiments, the vibration member 4300 can be provided in the second engagement portion 4112 or the protrusion 4140. Alternatively, any two of the first engagement portion 4111, the second engagement portion 4112 and the protrusion 4140 can be provided with the first vibration members 4300. Alternatively, each of the first engagement portion 4111, the second engagement portion 4112 and the protrusion 4140 can be provided with a first vibration member 4300.

Preferably, the outer housing 4100 is formed in one piece preferably made of a flexible material, preferably silicone. That is, the clamping part 4110, the positioning portion 4120, the first main body 4130, the second main body 4160 and the protrusion 4140 are formed in one piece.

In this embodiment, referring to FIGS. 22 to 24, the massager 4000 further includes an inner housing 4400 made of a rigid material, for example a rigid plastic. The inner housing 4400 includes a first inner housing portion 4400a received in the first main chamber 4131 of the outer housing 4100, and the second inner housing portion 4400b received in the second main chamber 4161 of the outer housing 4100. In this embodiment, the first inner housing portion 4400a includes a first housing half 4410 and a second housing half 4420 that are detachably connected with each other. The first housing half 4410 and the second housing half 4420 define a plurality of installation chambers for installing the driving mechanism 4200, a battery 4520 for powering the driving mechanism 4200, a circuit board 4530 electrically connected to the battery 4520 and the driving mechanism 4200 for controlling the driving mechanism 4200. The circuit board 4530 cooperates with a key portion 4133 on the first main body 4130 so that the operator can operate the massager 4000. The inner housing 4400 further includes a second inner housing portion 4400b received in the second main chamber 4161 of the outer housing 4100. In this embodiment, the second inner housing portion 4400b includes a third housing half 4430 and a fourth housing half 4440 that detachably connected with each other. The driving module 4600 is accommodated in the second inner housing portion 4400b. A cable for connecting the driving module 4600 to the battery 4520 and a cable for connecting the driving module 4600 to the circuit board 4340 are received in the connecting portion 4150.

In this embodiment, the positioning portion 4120 is finger-shaped. The massager 4000 further includes a second vibration member 4500 provided in the positioning portion 4120. The second vibration member 4500 is also preferably a vibration motor to perform vibration massage on the vagina or the rectum to improve the massage effect. The second vibration member 4500 may be electrically connected to the battery 4520 and powered by the battery 4520. It should be understood that the positioning portion 4120 may be other shapes such as an ellipsoid, a sphere, a cylinder or a general cylinder. As shown in FIG. 22, the positioning portion 4120 has a massaging cavity 4121 therein. The second vibration member 4500 is accommodated in the massaging cavity 4121.

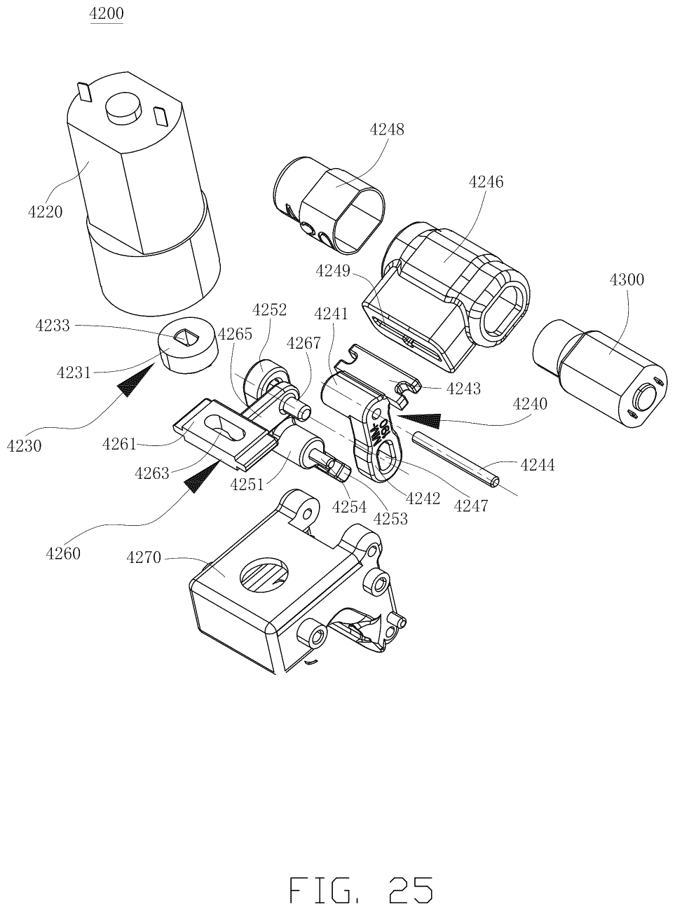

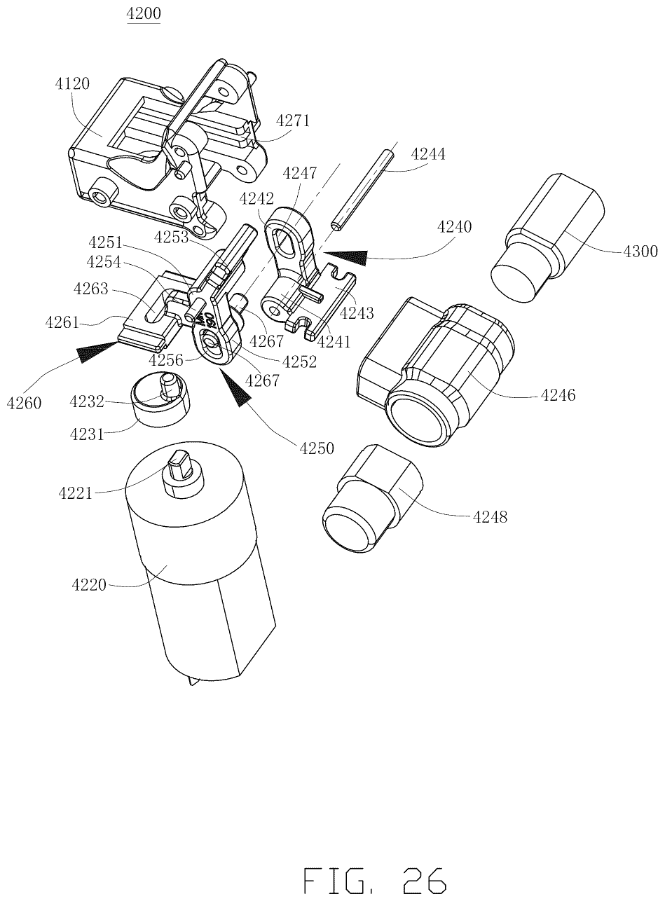

In this embodiment, referring to FIG. 25 and FIG. 26, the driving mechanism 4200 includes a first driving source 4220, a first eccentric wheel 4230 connected to a first driving shaft 4221 of the first driving source 4220, a first swing member 4240, a second swing member 4250 and a sliding member 4260. The first swing member 4240 and the second swing member 4250 are arranged at an angle relative to one another. The sliding member 4260 is connected to the first eccentric wheel 4230, and the first swing member 4240 and the second swing member 4250 are connected to the sliding member 4260 respectively. The driving mechanism 4200 further includes a bracket 4270 connected to the inner housing 4400.

In this embodiment, the first eccentric wheel 4230 includes a first wheel 4231 and a second wheel 4232. An eccentric connection hole 4233 is defined in the first wheel 4231 in one side of the first wheel 4231 for connecting with the first driving shaft 4221 of the first driving source 4220. As shown in the figure, in this embodiment, the connection hole 4233 is a general rectangular hole. Correspondingly, the first driving shaft 4221 is also general rectangular. Therefore, the first driving shaft 4221 of the first driving source 4220 and the first eccentric wheel 4230 are prevented from rotating relative to each other, so that the first eccentric wheel 4230 can rotate synchronously with the first driving shaft 4221. The second wheel 4232 is eccentrically located at the other side of the first wheel 4231.

In this embodiment, the sliding member 4260 includes a main plate 4261 defining a first guiding slot 4263 for receiving the second wheel 4232, and the second wheel 4232 is slidable along a first axis in the first guiding slot 4263. When the first eccentric wheel 4230 rotates, the sliding member 4260 is slidably along a second axis perpendicular to the first axis. The sliding member 4260 further includes an extending portion 4265 connected to the main plate 4261 and two supporting shafts 4267 connected to the extending portion 4265. The bracket 4270 defines a guiding groove 4271, and the main plate 4261 is slidably received in the guiding groove 4271.

The first swing member 4240 includes a first mounting post 4241, a first collar 4242, a first swing arm 4243 and a receiving sleeve 4246. The first collar 4242 and the first swing arm 4243 are arranged at two opposite sides of the first mounting post 4241. The first mounting post 4241 is rotatably supported in the bracket 4270 through a first rotation shaft 4244. The first collar 4242 defines a second guiding slot 4247 for slidably receiving one of the supporting shafts 4267. When the sliding member 4260 slides, the supporting shaft 4267 of the sliding member 4260 pushes the first swing member 4240 rotating around the first rotation shaft 4244. The first swing member 4240 further includes a shell 4248 received in the receiving sleeve 4246 and is configured to receive a portion of the first vibration member 4300. The first swing arm 4243 extends out of the inner housing 4400. The receiving sleeve 4246 is connected to the first swing arm 4243 and is configured for receiving the first vibration member 4300. Specifically, the first swing arm 4243 is engaged in an engaging hole 4249 defined in the receiving sleeve 4246 to connect the first swing arm 4243 with the receiving sleeve 4246. Further specifically, a cross section of the first swing arm 4243 and the engaging hole 4249 are rectangular. Alternatively, the first swing arm 4243 and the receiving sleeve 4246 are integrally formed.

The second swing member 4250 includes a second mounting post 4251, a second collar 4252 and a second swing arm 4253. The second collar 4252 and the second swing arm 4253 are arranged at two opposite sides of the second mounting post 2241. The second mounting post 4251 is rotatably supported in the bracket 4270 through a second rotation shaft 4254. The second collar 4252 defines a third guiding slot 4256 for slidably receiving the other one of the supporting shafts 4267. When the sliding member 4260 slides, the supporting shaft 4267 of the sliding member 4260 pushes the second swing member 4250 rotating around the second rotation shaft 4254.

In other words, in this embodiment, the at least one swing member includes the first swing arm 4243 and the second swing arm 4253. In this embodiment, he first swing arm 4243 extending out of the inner housing 4400 is received in the first accommodation chamber 4114 of the first engagement portion 4111 and supports the first engagement portion 4111. The second swing arm 4253 extending out of the inner housing 4400 is received in the second accommodation chamber 4115 of the second engagement portion 4112 and supports the second engagement portion 4112. When the first driving source 4220 works, the first driving shaft 4221 of the first driving source 4220 rotates, and the first eccentric wheel 4230 is driven to rotate by the first driving shaft 4221. The first eccentric wheel 4230 drives the first swing member d240 and the second swing member 4250 to swing around the first rotation shaft 4244 and the second rotation shaft 4254 respectively, so the first swing arm 4243 and the second swing arm 4253 will respectively drive the first engagement portion 4111 and the second engagement portion 4112 to move toward or away from each other simultaneously, thereby realizing clamping massage.

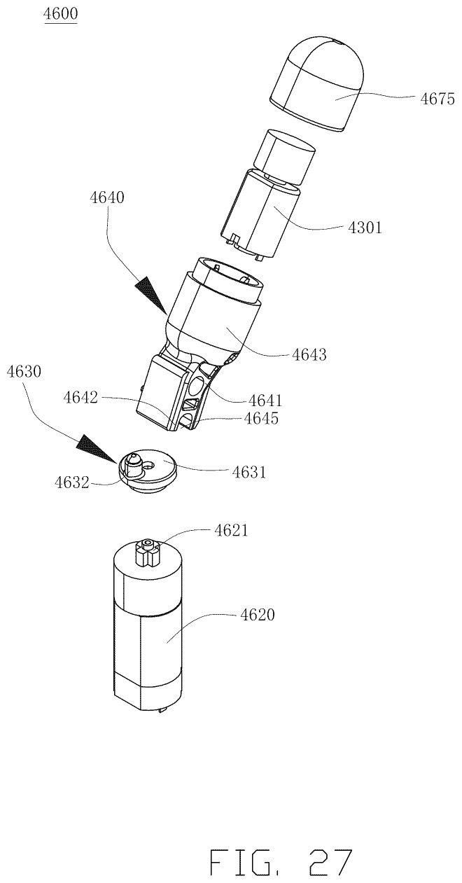

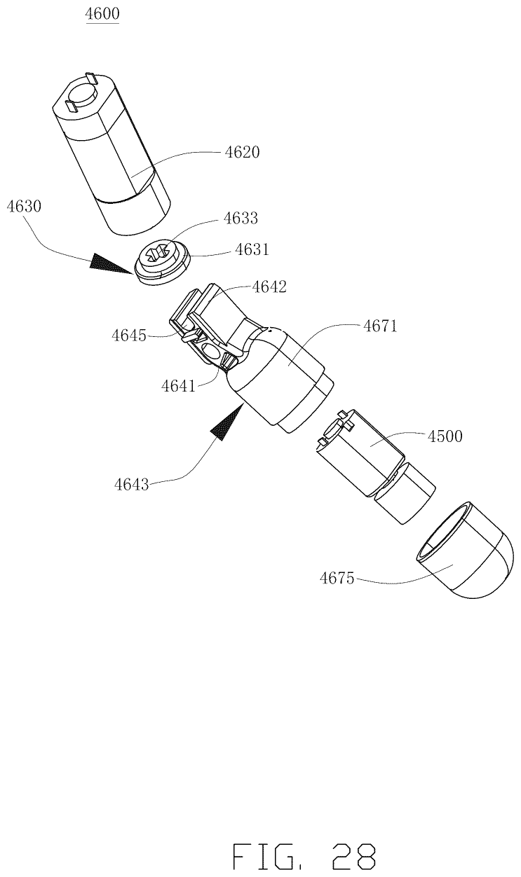

In this embodiment, referring to FIG. 27 and FIG. 28, the driving module 4600 includes a second driving source 4620, a second eccentric wheel 4630 connected to a second driving shaft 4621 of the second driving source 4620, and a third swing member 4640 that is connected to the second eccentric wheel 4630. Specifically, the second eccentric wheel 4630 includes a third wheel 4631 and a fourth wheel 4632. An eccentric connection hole 4633 is defined in the third wheel 4631 in one side of the first wheel 4231 for connecting with the second driving shaft 4621 of the second driving source 4620. As shown in the figure, in this embodiment, the connection hole 4633 is a plum blossom-shaped hole. Correspondingly, the second driving shaft 4621 is also plum blossom-shaped. Therefore, the second driving shaft 4621 of the second driving source 4620 and the second eccentric wheel 4630 are prevented from rotating relative to each other, so that the second eccentric wheel 4630 can rotate synchronously with the second driving shaft 4621. The fourth wheel 4632 is eccentrically located at the other side of the third wheel 4631.

In this embodiment, the third swing member 4640 is rotatably supported in the inner housing 4400 through a third rotation shaft 4644 (shown in FIG. 22). The third swing member 4640 includes a base block 4641, two plates 4642 connected to the base block 4641 and a swing rod 4643 connected to the base block 4641. The plates 4642 are separated from each other and opposite to each other, thus defining a swing slot 4645 between the two plates 4642. The swing rod 4643 extends out of the inner housing 4400 and is for receiving the second vibration member 4500. The fourth wheel 4632 of the second eccentric wheel 4630 faces the third swing member 4640 and movably received in the swing slot 4645. During rotation of the second eccentric wheel 4630, the fourth wheel 4632 pushes the plates 4642 to drive the third swing member 4640 swing around the third rotation shaft 4644. In the embodiment, the third rotation shaft 4644 is formed on the inner housing 4400.

In this embodiment, the swing rod 4643 includes a housing portion 4671 for receiving a portion of the second vibration member 4500. The housing portion 4671 is connected to the base block 4641. The driving module 4600 further includes a covering housing 4675 for receiving the rest portion of the second vibration member 4500.

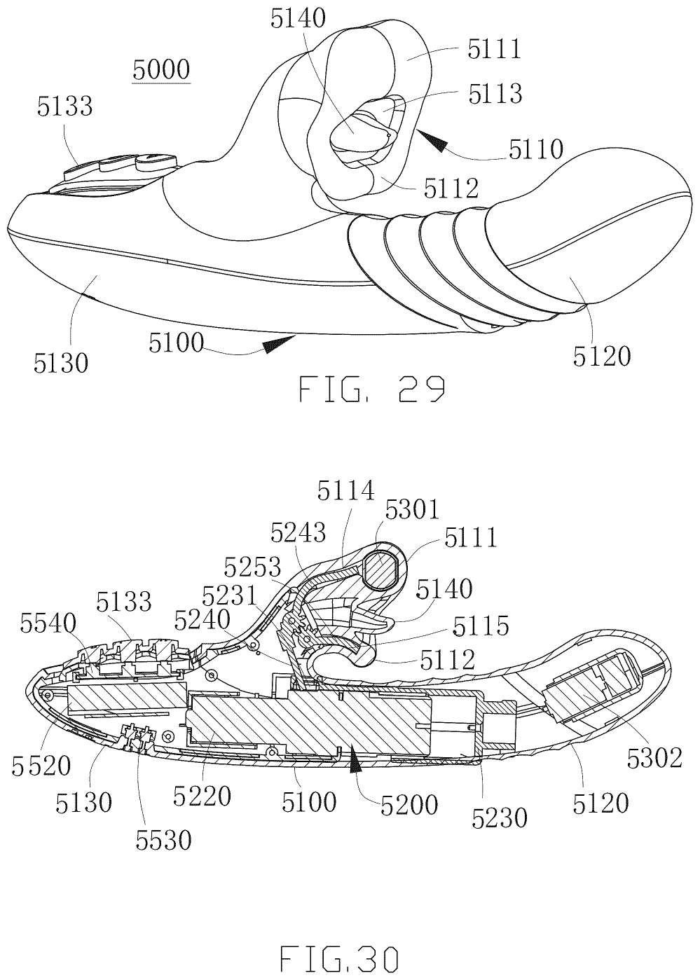

Referring to FIGS. 29 and 30, similar to the massager 1000 according to the first embodiment, the massager 5000 according to a fifth embodiment of the present disclosure also includes a clamping part 5110. The clamping part 5110 includes a first engagement portion 5111 and a second engagement portion 5112 that are opposite to each other. There is a cavity 5113 between the first engagement portion 5111 and the second engagement portion 5112, and a tongue-like protrusion 5140 is provided in the cavity 5113. In addition, the driving mechanism 5200 of the massager 3000 according to the third embodiment also includes a first swing arm 5243 and a second swing arm 5253, wherein the first swing arm 5243 is received in a first accommodation chamber 5114 of the first engagement portion 5111 and supports the first engagement portion 5111. The second swing arm 5253 is received in a second accommodation chamber 5115 of the second engagement portion 5112 and supports the second engagement portion 5112. The first swing arm 5243 and the second swing arm 5253 are configured to drive the first engagement portion 5111 and the second engagement portion 5112 to move toward or away from each other simultaneously to achieve clamping massage. However, the specific working principle and structure of the driving mechanism 5200 of the massager 5000 according to the third embodiment are different from those of the driving mechanism 1200 according to the first embodiment, and the positioning portion 5120 of the massager 5000 according to the third embodiment is also different from the positioning portion 1120 according to the first embodiment.

As shown in the figure, the positioning portion 5120 of the massager 5000 according to the fifth embodiment is an elongated stick. The stick has a length in a range of 2-30 cm. It should be noted that the stick can be straight or slightly curved, and the diameter of the stick can be varied as required. In addition to the clamping part 5110 and the positioning portion 5120, the outer housing 5100 according to the third embodiment further includes a handle portion 5130. In the present embodiment, the handle portion 5130 and the positioning portion 5120 together form an arc-shaped stick. The clamping part 5110 is connected between the handle portion 5130 and the positioning portion 5120 and is arranged at an angle relative to the positioning portion 5120. Specifically, the clamping portion 5110 and the handle portion 5130 are connected to the rear end of the positioning portion 5120, wherein the clamping portion 5110 is arranged at an angle relative to the positioning portion 5120, and the front end of the positioning portion 5120 is a free end. During use, the positioning portion 5120 can be inserted into the vagina or the rectum of woman/man to achieve positioning, preventing the massager 5000 from falling off and providing a good user experience. Further, the massager 5000 according to the third embodiment cannot only provide clamping massager through the clamping part 5110, but can also massage and stimulate the vagina or the rectum of woman/man through the stick-like positioning portion 5120, to improve the sex life of the man/woman.

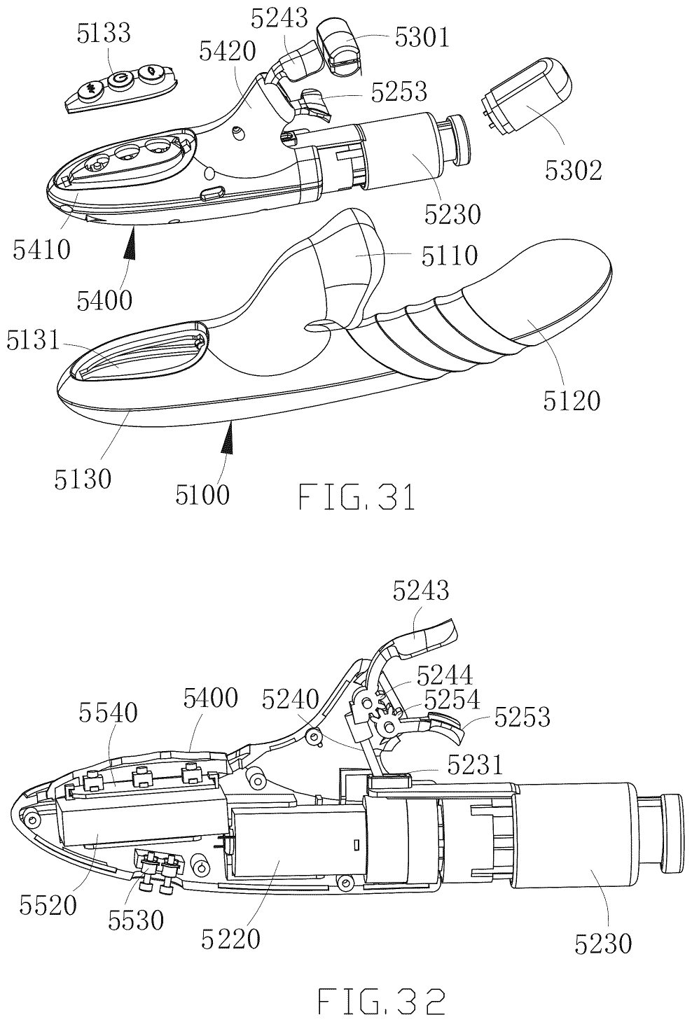

Referring to FIG. 31 and FIG. 32, the clamping part 5110, the positioning portion 5120 and the handle portion 5130 of the outer housing 5100 according to the third embodiment are all hollow. The inner housing 5400 of the massager 5000 includes a main body 5410 received in the handle portion 5130, and a branch portion 5420 connected at an angle to an end of the main body 5410 and received in the clamping part 5110. The main body 5410 is installed with a driving source 5220 of the driving mechanism 5200, a battery 5520, a first circuit board 5530 electrically connected to the battery 5520, and a second circuit board 5540 electrically connected to the driving source 3220 for controlling the driving source 5220. The second circuit board 5540 cooperates with a button portion 5133 which can be fixedly connected with the main body 5410 of the inner housing 5400, for example, by snapping with the main body 5410 of the inner housing 5400, and exposed to an opening 5151 of the handle portion 5130 of the outer housing 5100 for operation.

Preferably, in addition to the first vibration member 5301 received in the first accommodation chamber 5114 of the first engagement portion 5111 (instead of being received in the receiving sleeve 5246 of the first swing arm 5243 disclosed in the first embodiment), the massager 5000 according to the third embodiment further includes a second vibration member 5302 accommodated in the front end of the positioning portion 5120. The second vibration member 3302 is also preferably a vibration motor to perform vibration massage on the vagina or the rectum to improve the massage effect.

In this embodiment, the driving mechanism 5200 includes the driving source 5220, a movable sleeve 5230 connected to the driving source 5220, a swing component 5240 connected to the movable sleeve 5230, and the first swing arm 5243 and the second swing arm 5253. The driving source 5220 is configured to drive the movable sleeve 5230 to move back and forth. For example, the driving source 5220 can be a linear motor. The movable sleeve 5230 is installed in the chamber of the hollow positioning portion 5120, so that when the movable sleeve 5230 moves back and forth, the positioning portion 5120 (as stated above, the outer housing 5100 is made of a flexible material) will deform so that the free end of the positioning portion 5120 also moves back and forth to stimulate the vagina or rectum. Further, the outer surface of the movable sleeve 5230 has a slide groove 5251. In this embodiment, the swing component 5240 is configured as a rod, one end of which is movably received in the slide groove 5251, and the other end is connected to a first end of the first swing arm 5243. Preferably, a first gear 5244 is provided at the first end of the first swing arm 5243. It is also preferred that the swing component 5240, the first swing arm 5243 and the first gear 5244 are formed in one piece. A second gear 5254 is provided at a first end of the second swing arm 5253. The second gear 5254 meshes with the first gear 5244. Therefore, when the driving source 5220 drives the movable sleeve 5230 to move back and forth, the swing component 5240 will be driven to swing by the movable sleeve 5230, thereby driving the first swing arm 5243 and the second swing arm 5253 to swing, toward or away from each other simultaneously, respectively around centers of the first gear 5244 and the second gear 5254, so the first engagement portion 5111 and the second engagement portion 5112 will move toward or away from each other simultaneously, thereby achieving clamping massage.

In other embodiments, the driving mechanism 5200 may not include the second swing arm 5253 but the first swing arm 5243. That is, the second engagement portion 5112 can remain stationary, while the first engagement portion 5111 is driven by the first swing arm 5243 to move toward or away from the second engagement portion 5112, thereby achieving clamping massage.

While the disclosure has been particularly shown and described in conjunction with exemplary embodiments, it will be appreciated that variations and modifications will occur to those skilled in the art. The embodiments according to the present disclosure may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the disclosure. In addition, while a particular feature of the disclosure may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the disclosure.

1. A massager, comprising:
a clamping part, comprising a first engagement portion and a second engagement portion which are opposite to each other, with a cavity defined between the first engagement portion and the second engagement portion;
a driving mechanism, comprising at least one swing arm which is disposed in at least one of the first engagement portion and the second engagement portion for driving the at least one of the first engagement portion and the second engagement portion to move toward or away from the other;
a positioning portion which performs as a massaging portion; and
a driving member provided in the positioning portion to drive the positioning portion to move or to vibrate.

2. The massager of claim 1, wherein the driving member in the positioning portion comprises a vibration member to vibrate the positioning portion and/or a driving source to drive the positioning portion move back and forth.

3. The massager of claim 1, wherein two ends of the first engagement portion are respectively connected to two ends of the second engagement portion to define two opposite connection portions, and the first engagement portion and the second engagement portion enclose the cavity.

4. The massager of claim 1, wherein the clamping part further comprises a protrusion located in the cavity and between the first engagement portion and the second engagement portion, and the protrusion is made of a flexible material.

5. The massager of claim 3, wherein the massager further comprises at least one vibration member, and the at least one vibration member is disposed in at least one of the first engagement portion, the second engagement portion and the protrusion.

6. The massager of claim 1, wherein further comprises a main body and a connecting portion, the clamping part is connected to the main body, the connecting portion is made of a flexible material, the connecting portion is disposed between the main body and the positioning portion, and the connecting portion is bendable.

7. The massager of claim 6, wherein the connecting portion is a long and small cylinder, and a length of the connecting portion is larger than a length of any of the main body and the positioning portion.

8. The massager of claim 1, wherein the positioning portion is a general cylindrical sleeve defining a holding cavity.

9. The massager of claim 8, wherein the positioning portion comprises a base portion and two side portions connected to the base portion, a first end of the two side portions are connected to opposite sides of the base portion respectively and a second end of the two side portions extend towards each other, thus the holding cavity.

10. The massager of claim 8, wherein further comprises a main body for connecting the clamping part and the positioning portion, the holding cavity faces the cavity of the clamping part.

11. The massager of claim 1, wherein the massager further comprises a driving module, the positioning portion is swingable driven by the driving module.

12. The massager of claim 11, wherein further comprises a first main body, a second main body and a connecting portion, the clamping part is connected to the first main body, the connecting portion is made of a flexible material, the connecting portion is disposed between the first main body and second main body, the second main body is configured for connecting the connecting portion and the positioning portion, the positioning portion is swingable relative to the second main body, and the connecting portion is bendable.

13. The massager of claim 12, wherein the driving module comprises a driving source, an eccentric wheel connected to a driving shaft of the driving source and a swing member that is connected to the eccentric wheel, the eccentric wheel comprises a first wheel and a second wheel, an eccentric connection hole is defined in the first wheel in one side of the first wheel for connecting with the driving shaft of the second driving source, the swing member is rotatably supported through a rotation shaft, the swing member defines a swing slot facing the second wheel, and the second wheel is movably received in the swing slot.

14. The massager of claim 13, wherein the swing member comprises a base block, two plates connected to the base block and a swing rod connected to the base block, the plates are separated from each other and opposite to each other, thus defining the swing slot between the two plates; the swing rod comprises a housing portion for receiving at least a portion of the vibration member.

15. The massager of claim 1, wherein the at least one swing arm consists of a first swing arm and a second swing arm, the first swing arm is disposed in the first engagement portion, the second swing arm is disposed in the second engagement portion, and the first swing arm and the second swing arm are configured to drive the first engagement portion and the second engagement portion to move toward or away from each other simultaneously.

16. The massager of claim 15, wherein the driving mechanism comprises a driving source, a first eccentric wheel connected to a driving shaft of the driving source, a first swing member, a second swing member and a sliding member, the first swing member and the second swing member are arranged at an angle relative to one another, the sliding member is connected to the first eccentric wheel, and the first swing member and the second swing member are connected to the sliding member respectively, the driving mechanism further comprises a bracket; the first eccentric wheel comprises a first wheel and a second wheel slidably in a first guiding slot of the sliding member; a first mounting post of the first swing member is rotatably supported in the bracket through a first rotation shaft, a supporting shaft of the sliding member is slidably received in a second guiding slot of the first swing member; a second mounting post of the second swing member is rotatably supported in the bracket through a second rotation shaft, another supporting shaft is slidably received in a third guiding slot.

17. The massager of claim 1, wherein the at least one swing arm consists of a first swing arm, the first swing arm is disposed in the first engagement portion, and the first swing arm is configured to drive the first engagement portion to move toward or away from the second engagement portion.

18. The massager of claim 17, wherein the driving mechanism comprises a driving source, an eccentric wheel connected to a driving shaft of the driving source, and a swing member that is connected to the eccentric wheel; an eccentric connection hole is defined in one side of the eccentric wheel for connecting with the driving shaft of the driving source; the swing member comprises a mounting post, a collar and the first swing arm respectively connected to two sides of the mounting post, the mounting post is rotatably supported through a rotation shaft; the collar has a slide groove so that it can be arranged around the eccentric wheel, and the eccentric wheel is slidably received in the slide groove.

19. The massager of claim 17, wherein the driving mechanism comprises a driving source, and eccentric wheel connected to a driving shaft of the driving source, and a swing member that is connected to the eccentric wheel; a center connection hole is defined in one side of the eccentric wheel for connecting with the driving shaft of the driving source; the swing member is rotatably supported through a rotation shaft, the swing member comprises the first swing arm and defines a swing slot; the eccentric wheel forms an eccentric pole on one side of the eccentric wheel, the eccentric pole faces the swing member and is movably received in the swing slot.

20. The massager of claim 1, wherein the massager further comprises at least one circuit board and a battery, the massager further comprises an inner housing made of a rigid material, the inner housing is configured to receive the battery and the circuit board.
